(19) United States
(12) Patent Application Publication
(10) Pub. No.: US 2025/0307797 A1
(43) Pub. Date: Oct. 2, 2025

(54) DATA TRANSACTION APPLICATION TRANSMISSION ACROSS DEVICES

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/624,500

(22) Filed: Apr. 2, 2024

(51) Int. Cl. G06Q 20/32; G06Q 20/10

(52) U.S. Cl. CPC G06Q 20/322; G06Q 20/10

(57) ABSTRACT

In aspects of data transaction application transmission across devices, a first client device can obtain a request to transmit, for display at a second client device, an instance of an application associated with a data transaction. The first client device can output, for display at the first client device, a message indicating a stored balance associated with a payment service fails to satisfy a threshold value associated with the data transaction. The first client device can transmit, to the second client device and in response to a determination that the stored balance is updated to satisfy the threshold value, the instance of the application associated with the data transaction. The second client device can receive, from the first client device, the instance of an application. The second client device can output, for display at the second client device, the instance of the application.

### BACKGROUND

Devices, such as smart devices, mobile devices (e.g., cellular phones, tablet devices, smartphones), consumer electronics, and the like, can be implemented for use in a wide range of environments and for a variety of different applications. A mobile device may include, or implement, one or more applications. For example, the applications may include one or more purchase applications (e.g., financial applications, payment applications, shopping applications, subscription applications, etc.). A user of the mobile device may provide input, such as via a user interface displaying an instance of the application. The mobile device can execute a data transaction in response to the user input. In some examples, such as for a purchase application, the data transaction may include exchange of data related to a purchase of an item listed for sale via the purchase application. The data can include, but is not limited to, a value of the item (e.g., cost) and a merchant or other category of the item. The mobile device can deduct a value from a stored balance for the user via the payment service.

### BRIEF DESCRIPTION OF THE DRAWINGS

Implementations of the techniques for data transaction application transmission across devices are described with reference to the following Figures. The same numbers may be used throughout to reference like features and components shown in the Figures:

FIG. 1 illustrates an example system for data transaction application transmission across devices in accordance with one or more implementations as described herein.

FIG. 2 illustrates an example process flow, which supports data transaction application transmission across devices in accordance with one or more implementations as described herein.

FIGS. 3 through 6 further illustrate example systems for data transaction application transmission across devices in accordance with one or more implementations as described herein.

FIG. 7 further illustrates an example block diagram for data transaction application transmission across devices in accordance with one or more implementations as described herein.

FIGS. 8 and 9 illustrate example methods for data transaction application transmission across devices in accordance with one or more implementations of the techniques described herein.

FIG. 10 illustrates various components of an example device that can be used to implement the techniques for data transaction application transmission across devices as described herein.

### DETAILED DESCRIPTION

Implementations of techniques for data transaction application transmission across devices are described herein. In some examples, a device (e.g., mobile device or client device) may implement one or more applications or services. For example, the device may implement one or more purchase applications for purchasing one or more items listed for sale via the application, including, but not limited to, material goods, food, services, or media content, among other items. The purchase application may interface with or implement a payment service. In variations, the application receives user input triggering execution of a data transaction to purchase one or more items listed for sale. For example, a user may provide user input selecting the items and confirming a purchase of the items via a user interface displaying an instance of the application. The payment service deducts a value from a stored balance based on a value or price of the items.

In some examples, a device may support transmission of an instance of the application across devices. For example, a device may receive user input indicating for the device to transmit an instance of the application to another device, including one or more credentials or other application data of the application. That is, the device may transmit an instance of the application implemented at a first device to a second device, such that a user of the second device may interact with the instance of the application (e.g., using login credentials and/or other application data of a user of the first device). A user of the second device may provide user input to initiate a data transaction (e.g., to purchase an item) via the instance of the application. However, a stored balance for a payment service accessed by the instance of the application may not be sufficient to purchase an item. Additionally, or alternatively, the second device may not be authorized to execute a data transaction, access the stored balance for the payment service, or both. A user of the second device may attempt to execute the data transaction but may be denied due to insufficient funds or due to lack of authorization. The second device transmits signaling to the first device to request additional funds or to request authorization, which leads to increased use of processing and memory resources, as well as increased signaling overhead due to processing an attempt to execute the data transaction, transmitting signaling requesting additional funds, transmitting signaling requesting authorization, or any combination thereof.

As described herein, to reduce usage of processing and memory resources and to reduce signaling overhead related to one or more of insufficient funds or lack of authorization for devices implementing application transmission across the devices, a device can output a message indicating a stored balance for a payment service is insufficient prior to transmission of an instance of an application to another device. The device may obtain a request to transmit an instance of an application (e.g., a purchase application) to another device. For example, a user may provide user input, such as via a user interface and/or one or more sensors of the device, that triggers transmission of the instance of the application from a device of the user to another device. The device of the user determines that a stored balance for a payment service is insufficient (e.g., fails to satisfy a threshold value) for a data transaction via the instance of the payment application. Additionally, or alternatively, the device of the user determines that the other device is not authorized to access the balance for the payment service. The device outputs a message via a user interface that indicates the insufficient stored balance, requests a user to update (e.g., increase) the stored balance, and/or requests a user to authorize another device for accessing the stored balance. The device transmits the instance of the application to another device if the device determines that the stored balance is updated to satisfy a threshold value (e.g., a defined maximum value and/or a value of a data transaction) and/or that the other device is authorized to execute a data transaction via the instance of the application. The other device may output the instance of the application for display. The device and/or the other device may execute the data transaction upon receiving user input triggering the execution of the data transaction.

In some examples, a first device detecting that a stored balance is insufficient or that a second device is unauthorized to access the stored balance prior to transmitting an instance of an application to the second device may provide for reduced use of computational resources (e.g., processing resources, memory resources, communication resources etc.). For example, a first device may output a message indicating the insufficient stored balance for a data transaction via the instance of the application and/or unauthorized access to the instance of the application and may transmit the instance of the application upon a determination that the stored balance is updated and/or the second device is authorized. Thus, the second device may output the instance of the application and receive an indication to execute the data transaction without exchanging additional signaling requesting authorization and/or an increase in stored balance and without attempting to execute the data transaction multiple times.

While features and concepts of the described techniques for data transaction application transmission across devices can be implemented in any number of different devices, systems, environments, and/or configurations, implementations of the techniques for data transaction application transmission across devices are described in the context of the following example devices, user interfaces, systems, and methods.

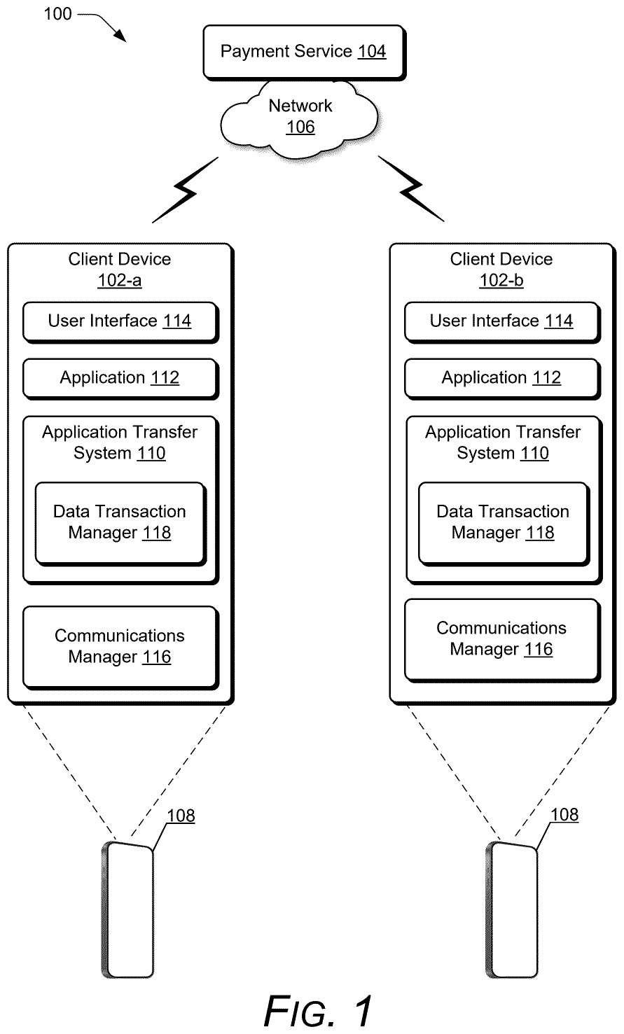

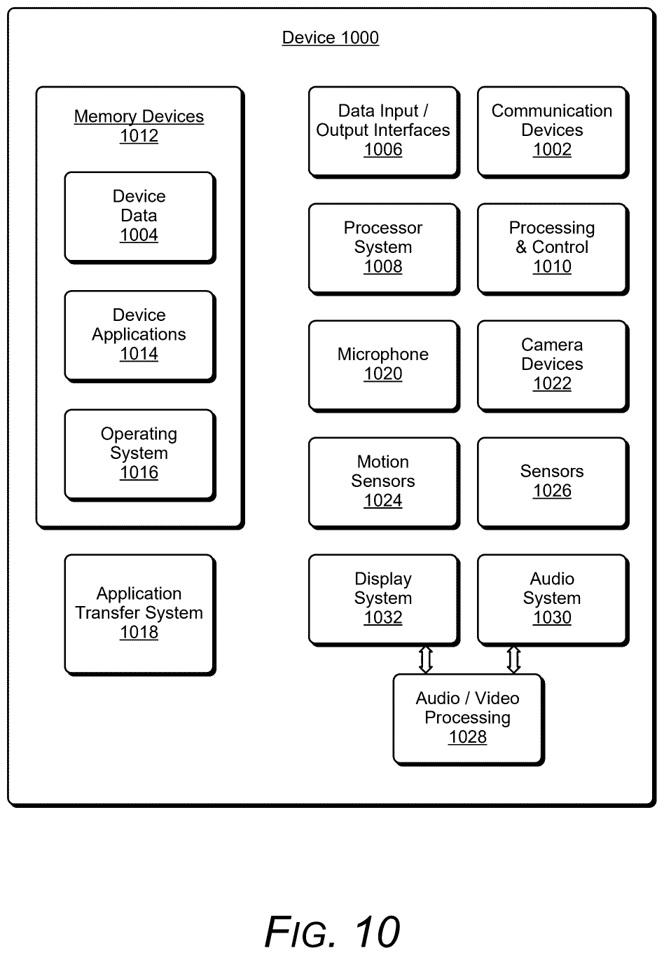

FIG. 1 illustrates an example system 100 for data transaction application transmission across devices, as described herein. The example system 100 includes a client device 102-a, a client device 102-b, and a payment service 104, where the client device 102-a, the client device 102-b, and the payment service 104 are interconnectable via one or more networks 106. In some examples, the client device 102-a and/or the client device 102-b includes a server device, a smartphone, a mobile phone, and/or any other type of wireless device or mobile device 108. The client device 102-a and/or the client device 102-b can be implemented with various components, such as a processor system and memory, as well as any number and combination of different components as further described with reference to the example device shown in FIG. 10. In implementations, the client device 102-a and/or the client device 102-b includes various radios for wireless communication with other devices (e.g., via the networks 106). For example, the client device 102-a and/or the client device 102-b may include a Bluetooth (BT) and/or Bluetooth Low Energy (BLE) transceiver and/or a near field communication (NFC) transceiver. The client device 102-a and/or the client device 102-b can also include a Wi-Fi radio, a global positioning system (GPS) radio, and/or any type of device communication interfaces.

A client device (e.g., the client device 102-a and/or a client device 102-b) may be configurable in a variety of ways. A client device, for instance, is configurable as a desktop computer, a laptop computer, a mobile device 108 (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a client device ranges from a full resource device with substantial memory and processor resources to a low-resource device with limited memory and/or processing resources. Although in instances in the following discussion reference is made to a client device in the singular, a client device may also be representative of multiple different devices. Although the client device 102-a and the client device 102-b are illustrated as including the same features, the client device 102-a and the client device 102-b may include different features in addition to, or as an alternative to, the features illustrated in the system 100.

In some examples, a client device 102-a and/or the client device 102-b may implement an application transfer system 110 for transmitting or receiving instances of an application 112. An instance of the application 112 refers to a current version of the application 112 running at the client device 102-a and/or the client device 102-b. In one or more implementations, the application transfer system 110 includes independent processing, memory, and/or logic components functioning as a computing and/or electronic device integrated with the client device 102-a and/or with the client device 102-b. Alternatively, or in addition, the application transfer system 110 can be implemented in software, in hardware, or as a combination of software and hardware components. In one or more examples, the application transfer system 110 is implemented as a software application or module, such as executable software instructions (e.g., computer-executable instructions) that are executable with a processor system of the client device 102-a and/or the client device 102-b to implement the techniques and features described herein. As a software application or module, the application transfer system 110 is stored on computer-readable storage memory (e.g., memory of a device), or in any other suitable memory device or electronic data storage implemented with the module. Alternatively, or in addition, the application transfer system 110 is implemented in firmware and/or at least partially in computer hardware. For example, at least part of the application transfer system 110 is executable by a computer processor, and/or at least part of the application transfer system 110 is implemented in logic circuitry.

In some cases, at least a portion of the application transfer system 110 is implemented by an application 112 of the client device 102-a and/or the client device 102-b. Additionally, or alternatively, at least a portion of the application transfer system 110 is implemented using various resources of the client device 102-a and/or the client device 102-b, such as hardware resources, an operating system, firmware, and so forth. Alternatively, or additionally, the application transfer system 110 is implemented by server-based storage resources, processing resources, and so on of devices other than the client device 102-a and/or the client device 102-b. For example, at least a portion of the application transfer system 110 can be implemented using a third-party service, such as a web services platform that provides one or more hardware and/or other computing resources to support provision of services by web service providers. In variations, an entirety, or various portions of the application transfer system 110 are implemented at or by the client device 102-a and/or the client device 102-b of a user (e.g., a mobile device 108, a laptop, a wearable device, or any other device). In the example system 100, the client device 102-a and the client device 102-b are mobile devices 108 that incorporate application transfer functionality.

The application transfer system 110 supports transmission of the instance of the application 112 between client devices, including, but not limited to, the client device 102-a and the client device 102-b. For example, the client device 102-a and/or the client device 102-b can receive user input that triggers the transmission of the instance of the application 112 between the client devices. The user input can include input received via a screen of the client device 102-a and/or the client device 102-b, such as touch input representative of a swiping motion towards a target client device to which the instance of the application 112 is to be transmitted. Additionally, or alternatively, the client device 102-a and/or the client device 102-b can receive user input via one or more interactable features of a user interface that indicates for the client device 102-a and/or the client device 102-b to transmit the instance of the application 112 to the target client device. In some examples, the user input can include an explicit indication of the target client device (e.g., via a text input field, a drop-down menu, or any other interactable feature of the user interface). In some other examples, the user input can include an implicit indication of the target client device, such as by indicating a direction of the target client device via touch input.

In variations, one or more client devices can include functionality for receiving and transmitting instances of the application 112. Additionally, or alternatively, client devices can include functionality for either transmitting or receiving the instance of the application 112. For example, the application transfer system 110 can designate a client device 102-a and a client device 102-b as both transmitting and receiving client devices. In some other examples, the application transfer system 110 can designate a client device 102-a as a transmitting client device, and a client device 102-b as a receiving client device, such that the client device 102-a can transmit an instance of an application 112 to the client device 102-b, but the client device 102-b may not have functionality or authorization to transmit an instance of the application 112 to the client device 102-a. In some cases, whether a client device has transmitting or receiving functionality can depend on one or more capabilities (e.g., hardware and/or software capabilities) of the client device, can be defined or configured by a user, or the like.

The application 112 causes various systems of the client device 102-a and/or the client device 102-b to output a user interface 114 of the application 112, such as by displaying a user interface 114 via a display device (e.g., a graphical user interface (GUI)) or making accessible voice-based user interfaces. Through interaction of a user with the client device 102-a and/or the client device 102-b, the application 112 receives user input via one or more user interfaces 114. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 112 is a browser, which is operable to navigate to a website, display pages of the website, and facilitate user interaction with web pages of the website. Another example of the application 112 is a web-based computer application, such as a mobile application or a desktop application. The application 112 may be configured in different ways, which enable users to interact with the client device 102-a and/or the client device 102-b and by extension perform actions, without departing from the spirit or scope of the techniques described herein.

In at least one implementation, the application 112 supports communication of data across the network(s) 106 between the client device 102-a and/or the client device 102-b. In variations, the application 112 may be a purchase application (e.g., financial applications, payment applications, shopping applications, subscription applications, etc.). Examples of purchase applications include, but are not limited to, an application that implements or communicates with a payment service 104 to provide for purchase of one or more goods, foods, services, or media, among other physical and/or virtual items. To purchase an item via the application 112, a user may provide user input indicating for the application 112 to execute a data transaction for purchasing the item. The data transaction may include signaling from the client device 102-a and/or the client device 102-b implementing the application 112 to the payment service 104 to verify a stored balance for the user (e.g., for a user account) and to verify that the user is authorized to execute the data transaction. Once the stored balance is verified and the user is authorized, the payment service 104 may deduct a value for the data transaction from the stored balance indicated by the signaling. For example, the signaling may indicate a value that includes the purchase price of the item, and the payment service 104 may deduct the value from the stored balance.

In variations, the application 112 may implement the payment service 104. For example, the payment service 104 may be integrated with the application 112, such that the application 112 maintains stored balances for respective user accounts of the application 112. Additionally, or alternatively, if the payment service 104 is integrated with the application 112, then the application 112 may maintain a list of authorized users to access the stored balance for respective user accounts. A user may provide user input, such as one or more account credentials (e.g., username, password) when initializing an instance of an application at the client device 102-a and/or the client device 102-b. The application 112 may store one or more respective balances for different user accounts and/or may store respective lists of users authorized to access (e.g., use) the stored balances at a database. The database may be a local database at the client device 102-a and/or the client device 102-b or may be a remote database or server for the payment service 104.

In some other variations, the application 112 interfaces with the payment service 104 by communicating via the networks 106. For example, the application 112 may transmit signaling to the payment service 104 to request a value of the stored balance, to indicate data transaction information, to indicate a user account for an instance of the application 112 that is executing the data transaction, or the like. The payment service 104 may implement, or may be implemented by, a separate application from the application 112 (e.g., a banking application or other financial application). In some examples, the payment service 104 may include one or more payment instruments, such as credit cards, debit cards, banking accounts, and cash applications, among other payment instruments, for accessing a stored balance. In some cases, a user may provide information related to a payments instrument (e.g., a debit card number, a credit card number, credentials linking a banking account, credentials linking a cash application, etc.) to the application 112.

The client device 102-a and/or the client device 102-b can include a communications manager 116 for transmitting and/or receiving signaling. The communications manager 116 represents functionality (e.g., logic and hardware) for enabling the client device 102-a and/or the client device 102-b to interconnect with other devices and/or networks, such as the networks 106. The communications manager 116, for instance, enables wireless and/or wired connectivity of client device 102-a and/or the client device 102-b. For example, the communications manager 116 represents one or more antennas for transmitting and receiving signaling from other devices and/or the payment service 104 via the networks 106. The networks 106 can include computer networks and/or telecommunication networks. For example, the networks 106 include a wireless local area network (WLAN), a wireless network, a BT network, a cellular network, a satellite network, and/or a fiber optic network. The networks 106 connect one or more devices, such as the client device 102-a, the client device 102-b, and the payment service 104, among others.

In some examples, the application transfer system 110 may implement a data transaction manager 118 with one or more functionalities related to execution of a data transaction when an instance of an application is shared across client devices. The application transfer system 110 and/or the data transaction manager 118 can be implemented as multiple instructions stored on computer-readable storage media and that can be executed by a processor system of the mobile device 108. Additionally or alternatively, the application transfer system 110 and/or the data transaction manager 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

In one or more examples, a connectivity session is established between the client device 102-a and the client device 102-b that enables the client device 102-a to send output content to and/or receive output content from the client device 102-b. In one or more implementations, the connectivity session is established via intercommunication between the application transfer system 110 of the client device 102-a and the application transfer system 110 of the client device 102-b. The output content is any type of digital video, images, audio, or application interfaces (e.g., an instance of an application), among others. In one or more implementations, the client device 102-b can output the output content at the device (e.g., at a user interface of the device).

In one or more implementations, the client device 102-a and the client device 102-b belong to a group of devices (e.g., a family group of devices). In one or more variations, the client device 102-a and/or the client device 102-b is a group leader device that is configured (e.g., via the application transfer system 110) to control one or more aspects of the group such as adding a device to the group, removing a device from the group, configuring group settings, setting device permissions within the group, and the like. In one or more examples, transferring an application from the client device 102-a to the client device 102-b is based on the application transfer system 110 determining that the client device 102-a and the client device 102-b being in the same group of devices.

In one or more examples, transferring an application from the client device 102-a to the client device 102-b is based on the client device 102-b being a default device among one or more default devices preselected for transfer of one or more applications 112. Additionally, or alternatively, transferring an application from the client device 102-a to the client device 102-b is based on the client device 102-b being a preferred device among one or more preferred devices preselected for transfer of one or more applications 112. Additionally or alternatively, transferring an application from the client device 102-a to the client device 102-b is based on the client device 102-b being a default device or preferred device for an application 112. For example, the application transfer system 110 indicates that the client device 102-b is a preferred device for a first application and that another mobile device in the group (and/or the client device 102-b) is a preferred device for a second application, and so on. Additionally or alternatively, the application transfer system 110 scans for available devices and the transferring of an application to the client device 102-b is based on the scan indicating that the client device 102-b is available to receive an application transfer and/or that the client device 102-b is within a given proximity of the client device 102-a (e.g., within a proximity threshold such as 100 feet, 1000 feet, 1 mile, etc.). Additionally or alternatively, the application transfer system 110 scans for available devices and the transferring of an application to the client device 102-b is based on the scan indicating that the client device 102-b is connected to a network 106 (e.g., is accessible) and/or that the client device 102-b is actively being used by a user.

When the application transfer system 110 determines a preferred device or default device is not available (e.g., not within a given proximity, not accessible, not active), then the application transfer system 110 selects another device from the group of devices. When no devices in the group are available, the application transfer system 110 generates and displays a notification on the client device 102-a that no devices are available. Additionally, or alternatively, the application transfer system 110 transmits a request (e.g., broadcasts the request) to one or more devices in the group to accept the request to transfer an application 112 (e.g., to receive a transfer of the application) from the client device 102-a. When the application transfer system 110 receives a response from one of the devices in the group approving the transfer, the application transfer system 110 transfers an instance of an application 112 to that device. When the application transfer system 110 receives (e.g., based on the broadcast message) multiple responses from one of the devices in the group approving the transfer, the application transfer system 110 selects at least one of the devices (e.g., a preferred device or default device) and transfers the instance of the application 112 to that device.

In some implementations, the application transfer system 110 detects a request and/or trigger event for transmitting the instance of the application 112 to another device. For example, the application transfer system 110 at the client device 102-a may receive user input requesting for the client device 102-a to transfer an instance of an application to the client device 102-b. In variations, a trigger event may include activation of an application 112 while another application is active on the client device 102-a, such as an active telephone call, an active video call, an active mobile application, and the like. Additionally, or alternatively, the trigger event may include activation of an application 112 while another application is scheduled for use on the client device 102-a (e.g., a scheduled call, a scheduled video call, etc.).

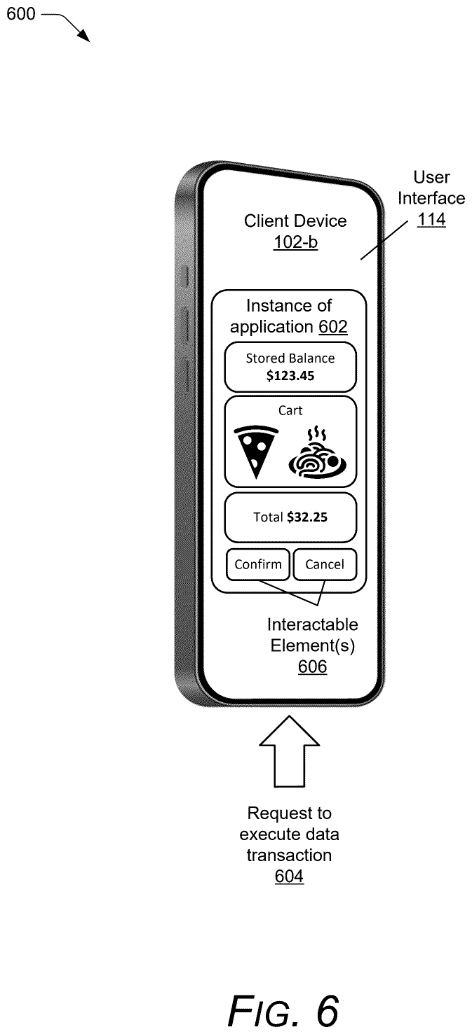

In some examples, the application transfer system 110 enables a user of the client device 102-a to transfer an interface or an instance of an application 112 to a client device 102-b, or vice-versa. For example, the user of the client device 102-a provides user input by touching a user interface 114 to simulate dragging or flinging the instance of the application 112 displayed at the client device 102-a towards the client device 102-b and/or towards a control displayed at the client device 102-a selectable to transfer the instance of the application 112. In some cases, the application transfer system 110 may transmit the instance of the application 112 to the client device 102-b (e.g., via the networks 106), and the client device 102-b may output the instance of the application 112 for display at a user interface 114. Thus, a user of the client device 102-b may control one or more aspects of the instance of the application 112, which is described in further detail with respect to FIG. 6.

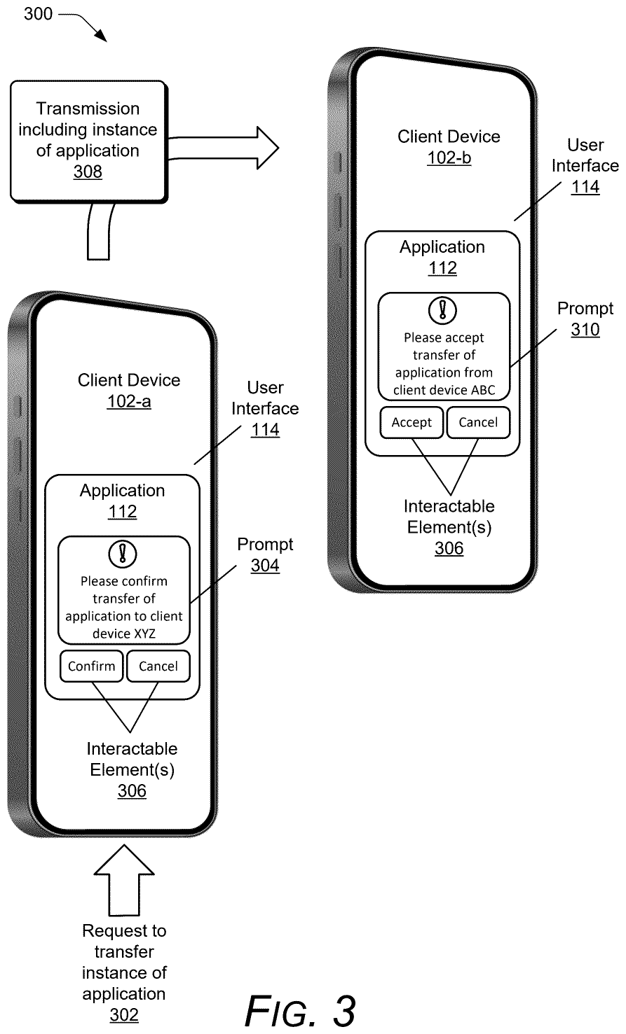

In some implementations, the application transfer system 110 transmits a message to the client device 102-b requesting that the client device 102-b receive the interface or the instance of the application 112, which is described in further detail with respect to FIG. 3. The client device 102-b may receive user input confirming the transfer of the instance of the application 112, which may provide for a continuous application experience between client devices without restarting the client device 102-a and the client device 102-b. In variations, the client device 102-b may receive user input (e.g., via the user interface 114) to select one or more items for sale via the instance of the application 112. The client device 102-b may also receive user input indicating a confirmation of purchase of the one or more items for sale via the instance of the application 112.

For example, a user of a client device 102-b may initiate an application, such as a work productivity application (e.g., an electronic messaging application, a voice call application, a video call application, a document editing application, etc.). In some cases, the user of the client device 102-a may manually determine to initiate another application (e.g., the application 112) for transfer to another client device 102-b. For example, the client device 102-a may receive user input (e.g., via the user interface 114) that initiates an instance of the application 112 and a request to transfer the instance of the application 112 to the client device 102-b. The user may request to transfer the instance of the application 112 to a client device 102-b of a family member, where the application 112 may be a purchase application for a food delivery service. In variations, the client device 102-a may transmit the instance of the application 112 to the client device 102-b, including information (e.g., login credentials) related to the instance of the application 112.

In some other cases, the client device 102-a automatically determines (e.g., without manual user input) to initiate an application 112 and transfer the application 112 to a client device 102-b. For example, the client device 102-a determines that an application is active at the client device 102-a and determines one or more other conditions are met for initializing the application 112 and transferring an instance of the application 112 to the client device 102-b. In some examples, the conditions may be based on application data collected by one or more applications implemented by the client device 102-a, such as schedule information associated with a calendar or other scheduling application of the client device 102-a, one or more text, audio, and/or video messages received by a messaging application, a pattern of use of applications implemented by the client device 102-a, among other application data. For example, the client device 102-a may determine a user of the client device 102-b requested purchase of an item via an application 112 (e.g., pizza by a food delivery service), and may initialize an instance of the application 112 and transmit the instance of the application 112 to the client device 102-b.

In some examples, the client device 102-b may receive and/or detect user input that indicates for the client device 102-b to execute a data transaction, such as to purchase an item for sale via the instance of the application 112. However, a stored balance for an account identifier linked to the instance of the application 112 (e.g., for a user account of a user of the client device 102-a) may be insufficient. That is, the stored balance may be less than or equal to a threshold value to execute the data transaction. An example data transaction includes, but is not limited to, signaling between the client device 102-a and/or the client device 102-b and the payment service 104 to cause a deduction or withdrawal of a value from the stored balance for payment when purchasing an item via the instance of the application 112. For example, the signaling may include an indication of the value of an item in a purchase confirmation, a user account identifier for a user account of the instance of the application 112, and/or an identifier of the client device 102-b (e.g., the client device that attempted to execute the data transaction).

In some examples, the client device 102-b may not be authorized to execute a data transaction. However, the client device 102-a may not notify a user of the insufficient funds (e.g., a stored balance fails to satisfy a threshold value) and/or the lack of authorization of the client device 102-b prior to transmitting the instance of the application 112 to the client device 102-b. Thus, the client device 102-b may transmit a message to the client device 102-a to request sufficient funds and/or to authorization of the client device 102-b after the instance of the application is sent to the client device 102-b and/or after the client device 102-b attempts to execute the data transaction. The client device 102-b attempting to execute the data transaction and/or the client device 102-b transmitting a request to the client device 102-a to provide sufficient funds may result in increased use of processing and memory resources, as well as an increase in signaling overhead (e.g., due to the additional signaling and/or multiple attempts to execute the data transaction). Additionally, or alternatively, the client device 102-a displays a notification to the user via a user interface 114 of the client device 102-a (e.g., requesting for the user to provide sufficient funds, indicating a one-time password (OTP) to authorize a data transaction, requesting for the user to authorize a client device 102-b, etc.), which may degrade user experience by interrupting an ongoing application at the client device 102-a.

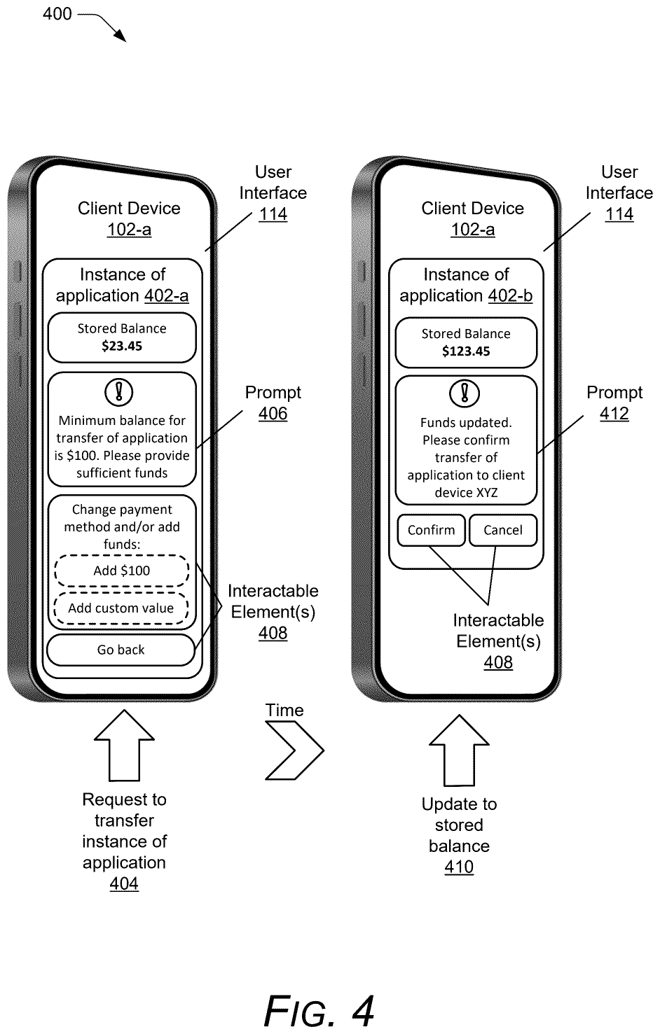

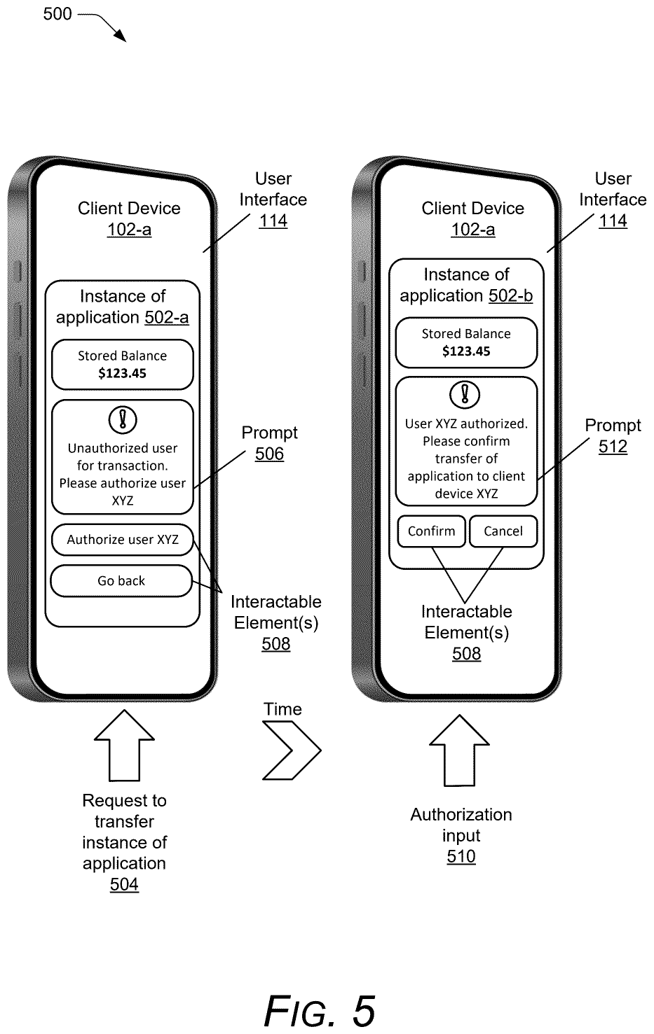

In some examples, to reduce use of computational resources (e.g., processing, memory, signaling) related to a stored balance failing to satisfy a threshold value and/or an unauthorized client device accessing the stored balance, a client device 102-a can output a notification to a user to indicate that the stored balance is insufficient and/or that the client device 102-b is unauthorized to access the stored balance prior to transmitting an instance of an application to the client device 102-b. For example, the client device 102-a can output a message including one or more string and/or character values (e.g., a text value) and/or can output one or more interactable or selectable elements via a user interface 114, which is described in further detail with respect to FIGS. 4 and 5.

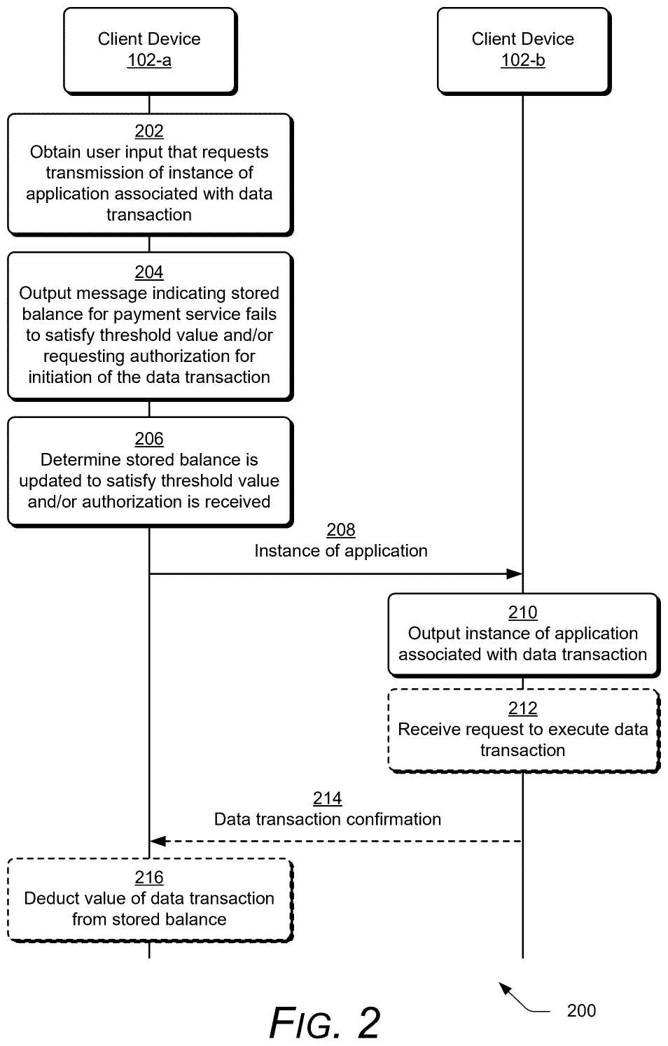

In some examples, the client device 102-a detects a request to transmit an instance of an application to a client device 102-b, which is described in further detail with respect to FIG. 2. The client device 102-a determines the application 112 supports data transactions. For example, the client device 102-a determines the application 112 is a purchase application that implements and/or communications with a payment service 104. Additionally, or alternatively, the client device 102-a determines a stored balance (e.g., wallet) is accessible via the instance of the application 112. For example, the stored balance may be accessible for withdrawals (e.g., for payment of purchases) by a user account or other identifier of the instance of the application 112. The client device 102-a determines that the stored balance has a value that does not satisfy a threshold value for the instance of the application 112. For example, the client device 102-a and/or a user of the client device 102-a may specify the threshold value according to one or more data transactions scheduled to be executed via the instance of the application 112 and/or one or more data transactions available to be executed via the instance of the application 112. Additionally, or alternatively, the client device 102-a and/or the user of the client device 102-a may specify a maximum value for one or more data transactions via the instance of the application 112, and the threshold value may be equal to the maximum value.

In some examples, if the stored balance fails to satisfy the threshold value (e.g., is insufficient), then the client device 102-a alerts or notifies a user of the client device 102-a to modify (e.g., update by increasing) the stored balance, which is described in further detail with respect to FIG. 4. A data transaction manager 118 of the client device 102-a compares the stored balance to a threshold value prior to transmitting an instance of the application 112 to a client device 102-b, such that the stored balance is sufficient (e.g., satisfies the threshold value) before the instance of the application 112 is shared to the client device 102-b. Additionally, or alternatively, the client device 102-a may provide for a user to authorize a secondary user (e.g., a user of the client device 102-b) to use the stored balance for data transactions via the instance of the application 112, including purchases of items listed for sale via the instance of the application 112. For example, the data transaction manager 118 of the client device 102-a may determine that a user of the client device 102-b is not authorized to use the stored balance and may indicate for the user interface 114 to display an option that is selectable by a user (e.g., via user input) to authorize one or more secondary users, which is described in further detail with respect to FIG. 5. Additionally, or alternatively, the client device 102-b may receive a request to execute a data transaction with a value that exceeds a threshold value specified for the client device 102-b. The client device 102-a may generate and display an authorization request via the user interface 114. The authorization request may include a message, notification, and/or alert requesting authorization to execute the data transaction at the client device 102-b.

In some examples, the client device 102-b and/or the client device 102-a execute the data transaction via the instance of the application 112 at the client device 102-b. For example, the client device 102-b may receive user input that indicates for the client device 102-b to execute the data transaction. In some examples, the client device 102-b executes a data transaction by transmitting a request to another client device and/or a server device that maintains one or more items that are listed for sale via the instance of the application 112. The payment service 104 can manage the exchange of funds for the data transaction, including a withdrawal of a value from a stored balance of a user account for the instance of the application 112 and/or a credit to a merchant account for the item. In some other examples, the client device 102-b transmits an indication to the client device 102-a to execute the data transaction. For example, the client device 102-a and the client device 102-b maintain a communication link while sharing an instance of the application 112, and the client device 102-a receives signaling from the client device 102-b indicating one or more actions for the client device 102-a to perform responsive to user input received at the client device 102-b. For example, the actions may include to display one or more messages to a user of the client device 102-a, to execute a data transaction, to process feedback indicating a user of the client device 102-b provided user input declining or accepting a transmission of an instance of the application 112 (e.g., and display an indication, accordingly), among other actions.

FIG. 2 illustrates an example process flow 200, which supports data transaction application transmission across devices in accordance with one or more implementations as described herein. The example process flow 200 may implement aspects of the example system 100. For example, the example process flow 200 can be implemented by a client device 102-a and a client device 102-b that support transfer of an instance of an application, where the client device 102-a and the client device 102-b may be examples of the corresponding devices as described with reference to FIG. 1. Alternative examples of the following may be implemented, where some processes are performed in a different order than described or are not performed. In some cases, processes may include additional features not mentioned below, or further processes may be added.

At 202, a client device 102-a obtains user input that requests transmission of an instance of an application associated with a data transaction. For example, the client device 102-a can receive user input via a user interface and/or via one or more sensors (touch sensors, audio sensors, video sensors, etc.) that indicates for the client device 102-a to transmit the instance of the application, as described with reference to FIG. 1. The user interface may include a GUI with interactable elements or features (drop-down menus, text input fields, selectable buttons, etc.). In variations, the client device 102-a determines that the application is a purchase application or implements a digital wallet, such as by using application data indicating one or more characteristics of the application. For example, the client device 102-a determines that the application supports data transactions for purchase of items listed for sale via the instance of the application, referred to as payment transactions. The data transactions can include exchange of data related to the purchase of the items, such as a merchant category, an item category, a value of the items (e.g., cost), among other information.

At 204, the client device 102-a outputs a message indicating a stored balance for a payment service fails to satisfy (e.g., is below, less than) a threshold value and/or requesting authorization for initiation of the data transaction. In some examples, the message can include a single message indicate that the stored balance fails to satisfy the threshold value and requesting authorization for the client device 102-b to initiate the data transaction via the instance of the application. In some other examples, the message can include a message indicate that the stored balance fails to satisfy the threshold value and an additional message requesting authorization for the client device 102-b to initiate the data transaction.

At 206, the client device 102-a can determine that a stored balance is updated to satisfy (e.g., be equal to or greater than) a threshold value and/or that authorization is received. For example, the client device 102-a receives user input that provides or credits the stored balance with a value, such that the stored balance satisfies the threshold value. In some other examples, the client device 102-a receives an indication (e.g., from a payment service, or other application at the client device 102-a) that the stored balance is updated to satisfy the threshold value. Additionally, or alternatively, the client device 102-a can obtain user input indicating that the client device 102-b is authorized to initiate execution of the data transaction via the instance of the application.

In some cases, the client device 102-b can define or configure the threshold value. In some other cases, the client device 102-b can receive user input that defines or configures the threshold value. The threshold value can include a maximum value allocated for the client device 102-b to use for a data transaction via the instance of the application. For example, a user of the client device 102-a can set a default threshold value, which may be a maximum value, that the user of the client device 102-b can spend via the instance of the application.

At 208, the client device 102-a can transmit the instance of the application to the client device 102-b. In some examples, the client device 102-a can transmit the instance of the application if the stored balance satisfies the threshold value, and the client device 102-b is authorized to initiate a data transaction via the instance of the application. Additionally, or alternatively, the client device 102-a can initiate a timer upon obtaining the user input at 202 and/or upon outputting the message at 204. The client device 102-a can transmit the instance of the application upon expiry of the timer.

At 210, the client device 102-b can output the instance of the application associated with the data transaction. For example, the client device 102-b can output a same instance of the application that was displayed at the client device 102-a prior to transmission of the instance of the application. The client device 102-b can output the instance of the application for display to a user of the client device 102-b via a user interface, such as a GUI.

At 212, the client device 102-b can receive a request to execute the data transaction. In variations, the client device 102-b can execute the data transaction upon receiving the request. In some other variations, the client device 102-b can transmit the request to initiate the data transaction to the client device 102-a, and the client device 102-a can execute the data transaction. Executing the data transaction can include exchanging signaling to facilitate a sale of an item (e.g., payment to a merchant for an item and coordinate delivery of the item) and deducting a value from the stored balance. The client device 102-b can receive the request via one or more interactable elements of a user interface. For example, a user can provide user input to submit an order for one or more items via an instance of an online marketplace application.

In some cases, at 214, the client device 102-b can transmit a data transaction confirmation indication to the client device 102-a. In some examples, such as if the client device 102-b executes the data transaction, the data transaction confirmation can include an indication that the data transaction is successfully executed and can include information related to the data transaction. Example information related to the data transaction can include, but is not limited to, a time stamp for the data transaction, a value of the data transaction, or any other information related to the data transaction. In some other examples, the data transaction confirmation can include an indication of the request to execute the data transaction.

In variations, at 216, the client device 102-a can deduct a value of the data transaction from a stored balance via the instance of the application. For example, the client device 102-a can deduct the value from a virtual wallet maintained by the application. In some other variations, the client device 102-a and/or the client device 102-b can transmit an indication of the value to a payment service system, and the payment service system can deduct the value from the stored balance, where the payment service system maintains the stored balance. The payment service system can be implemented by a cash application, a financial institution application, or any other payment service application.

The example process flow 200, as well as example method 800 and the example method 900, are described with reference to respective FIGS. 2, 8, and 9 in accordance with one or more implementations of data transaction application transmission across devices, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates an example system 300 for data transaction application transmission across devices in accordance with one or more implementations as described herein. The system 300 may implement aspects of the example system 100 and/or the process flow 200, as shown and described with reference to FIGS. 1 and 2. For example, the example system 300 may include a client device 102-a configured to transfer an instance of an application 112 to the client device 102-b, where the client device 102-a, the client device 102-b, and the application 112 may be examples of the corresponding features as described with reference to FIGS. 1 and 2. In variations, the client device 102-a and the client device 102-b include respective user interfaces 114, which may be examples of user interfaces 114 as described with reference to FIG. 1.

Although the system 300 depicts an example of transfer of an instance of an application 112 from the client device 102-a to the client device 102-b, the instance of the application 112 can additionally, or alternatively, be transferred from the client device 102-a to any numerical quantity of other client devices. Similarly, the instance of the application 112 can additionally, or alternatively, be transferred from the client device 102-b to the client device 102-a.

A client device 102-a can detect a request to transfer an instance of an application 302 to the client device 102-b (e.g., an instance of the application 112). In variations, the request to transfer the instance of the application 302 can be an explicit indication for the client device 102-a to transfer the instance of the application 112 to the client device 102-b. For example, the client device 102-a can receive user input (e.g., via the instance of the application 112, or via an instance of another application dedicated to transfer of instances of applications) that explicitly indicates for the client device 102-a to transfer the instance of the application 112 to the client device 102-b.

In some other examples, the request to transfer the instance of the application 302 can be an implicit indication for the client device 102-a to transfer the instance of the application 112 to the client device 102-b. For example, the client device 102-a can be running an instance of another application, such as a work productivity application, and the client device 102-a can receive a request to initialize the instance of the application 112. The client device 102-a can prompt the user to transmit the instance of the application 112 to the client device 102-b upon receiving the request to initialize the instance of the application 112. In some other examples, the client device 102-a can monitor application data for the application 112, as well as for other applications implemented by the client device 102-a. The client device 102-a can detect one or more patterns in the application data and can prompt the user to transmit the instance of the application 112 to the client device 102-b based on the patterns (e.g., by performing pattern analysis using one or more data processing techniques). For example, the client device 102-a can determine that the user of the client device 102-a is in meetings every Monday from 4:00 pm to 6:00 pm, or any other time interval, and can determine that the user of the client device 102-a initiates a food delivery application during the time interval frequently (e.g., greater than a threshold numerical quantity of times over a duration). The client device 102-a can automatically prompt the user via the user interface 114 of the client device 102-a to transfer the instance of the food delivery application to the client device 102-a.

Once the client device 102-a receives the request to transfer the instance of the application 302, the client device 102-a displays a prompt 304 to the user of the client device 102-a via a user interface 114 of the instance of the application 112. The prompt 304 can include a text value including one or more string and/or character values. For example, the prompt 304 can include a text value, “please confirm transfer of the application to the client device XYZ,” where XYZ is an identifier of the client device 102-b and/or a user of the client device 102-b. The client device 102-a can additionally, or alternatively, display one or more interactable elements 306 to the user of the client device 102-a via the user interface user interface 114 of the instance of the application 112. The interactable elements 306 can include, but are not limited to, button elements, drop-down menus, text field elements, or the like. The client device 102-a can receive user input selecting one or more of the interactable elements 306. For example, a user of the client device 102-a can provide user input selecting a button element labeled with “Confirm” to confirm transmission of the instance of the application 112 to the client device 102-b (e.g., by clicking the button element). In some other examples, the user of the client device 102-a can provide user input selecting a button element labeled with “Cancel” to cancel transmission of the instance of the application 112 to the client device 102-b.

In some examples, such as if the user of the client device 102-a selects the button element that confirms transfer of the instance of the application 112, the client device 102-a initiates transmission of the instance of the application 112. In some other examples, such as if the user of the client device 102-a selects the button element that cancels transfer of the instance of the application 112, the client device 102-a refrains from transmitting (e.g., does not transmit) the instance of the application 112 to the client device 102-b. In variations, the client device 102-a can load or buffer the instance of the application 112 prior to transmitting the instance of the application 112 to the client device 102-b. Loading the application 112 can include initializing a user profile (e.g., including one or more user credentials) for the user of the client device 102-a, such that the user of the client device 102-b can access the user profile without providing additional user credentials. In some examples, loading the application 112 can include displaying the instance of the application 112 via the user interface 114 of the client device 102-a. In some other examples, loading the application 112 can include refraining from displaying the instance of the application 112 via the user interface 114 of the client device 102-a.

The client device 102-b sends a transmission including the instance of the application 308 to the client device 102-b. Once the client device 102-b receives the instance of the application 308, the client device 102-b displays a prompt 310 to the user of the client device 102-b via a user interface 114 of the instance of the application 112. The prompt 310 can include a text value including one or more string and/or character values. For example, the prompt 310 can include a text value, “please accept transfer of the application from the client device ABC,” where ABC is an identifier of the client device 102-a and/or a user of the client device 102-a. The client device 102-b can additionally, or alternatively, display one or more interactable elements 306 to the user of the client device 102-b via the user interface user interface 114 of the instance of the application 112. The client device 102-b can receive user input selecting one or more of the interactable elements 306. For example, a user of the client device 102-b can provide user input selecting a button element labeled with “Accept” to accept the transmission including the instance of the application 308 from the client device 102-a (e.g., by clicking the button element). In some other examples, the user of the client device 102-b can provide user input selecting a button element labeled with “Cancel” to cancel the transmission including the instance of the application 308 from the client device 102-b.

In some examples, such as if the user of the client device 102-b selects the button element that confirm transfer of the instance of the application 112, the client device 102-b displays the instance of the application 112 via the user interface 114. The client device 102-b can transmit an indication to the client device 102-a that the transmission including the instance of the application 308 is accepted. In some other examples, such as if the user of the client device 102-b selects the button element that cancels transfer of the instance of the application 112, the client device 102-b can transmit an indication to the client device 102-a rejecting the transmission including the instance of the application 308, and can refrain from displaying (e.g., does not display) the instance of the application 112 at the client device 102-b.

Although the system 300 illustrates an example of user input triggering a transmission including an instance of the application 308, the client device 102-a can additionally, or alternatively, perform the transmission including the instance of the application 308 without user input. For example, the client device 102-a performs the transmission including the instance of the application 308 without displaying the prompt 304 and the interactable elements 306. The client device 102-a can detect a trigger condition or event and can initiate the transmission including the instance of the application 308, as described with reference to FIG. 1. In some cases, the client device 102-a can display a notification or message to the user of the client device 102-a that indicates the transmission including the instance of the application 308 is sent to the client device 102-b.

FIG. 4 illustrates an example system 400 for data transaction application transmission across devices in accordance with one or more implementations as described herein. The system 400 may implement aspects of the example system 100, the process flow 200, and/or the system 300 as shown and described with reference to FIGS. 1 through 3. For example, the example system 400 may include a client device 102-a configured to transfer an instance of an application 402-a and/or an instance of the application 402-b to another client device, where the client device 102-a and the application may be examples of the corresponding features as described with reference to FIGS. 1 through 3. In variations, the client device 102-a includes a user interface 114, which may be an example of a user interface 114 as described with reference to FIG. 1. For example, the client device 102-a can display the instance of the application 402-a and/or the instance of the application 402-b via the user interface 114.

A client device 102-a can detect a request to transfer an instance of an application 404 (e.g., the instance of the application 402-a) to another client device, as described with reference to FIG. 3. Once the client device 102-a receives the request to transfer the instance of the application 404, the client device 102-a can compare a stored balance to a threshold value (e.g., a threshold value of $100). The threshold value can be defined or configured by the client device 102-a and/or by a user of the client device 102-a. For example, the client device 102-a can receive user input indicating the threshold value. In some cases, the threshold value can be different for respective client devices that the client device 102-a is transferring the instance of the application 402-a to. In some other cases, the threshold value can be the same for different client devices that the client device 102-a is transferring the instance of the application 402-a to. The threshold value can be a minimum stored balance for transfer of the instance of the application 402-a to another client device.

The client device 102-a can display the stored balance via the user interface 114, such as a numerical value indicating the stored balance (e.g., $23.45). The stored balance can be any monetary value accessible by a user of the client device 102-a. In some cases, the client device 102-a can maintain the stored balance. In some other cases, a payment service system can maintain the stored balance and can communicate any changes to the stored balance to the client device 102-a for display. Maintaining the stored balance includes updating the stored balance when the account of the user of the client device 102-a is credited or withdrawn from.

In some examples, such as if the stored balance fails to satisfy a threshold value (e.g., is less than the threshold value), the client device 102-a can display a prompt 406 to the user of the client device 102-a via a user interface 114 of the instance of the application 402-a. The prompt 406 can include a text value including one or more string and/or character values. For example, the prompt 406 can include a text value, “Minimum balance for transfer of application is $100. Please provide sufficient funds.” In some other examples, such as if the stored balance satisfies a threshold value (e.g., is greater than or equal to the threshold value), the client device 102-a can display a prompt for transferring the application 402-a to another client device and/or can initiate transfer of the instance of the application 402-a to the other client device, as described with reference to FIG. 3.

The client device 102-a can additionally, or alternatively, display one or more interactable elements 408 to the user of the client device 102-a via the user interface user interface 114 of the instance of the application 402-a. The interactable elements 408 can include, but are not limited to, button elements, drop-down menus, text field elements, or the like. The client device 102-a can receive user input selecting one or more of the interactable elements 408. For example, a user of the client device 102-a can provide user input by selecting from one or more button elements labeled with “Change payment method and/or add funds” (e.g., by clicking the button element). For example, the client device 102-a can display one or more buttons with values to add to the stored balance that are preconfigured or defined. The client device 102-a can determine the values to display via the buttons based on a difference between the stored balance and the threshold value. In some cases, the client device 102-a can display one or more values selectable by the user to add a value to the stored balance that results in the stored balance satisfying the threshold value (e.g., “Add $100,” where the threshold value is $100, and the stored balance is $23.45). Additionally, or alternatively, the button can include a text value, such as “Add custom value,” that triggers the user interface 114 to display an option that is selectable by the user to provide a numerical value as input indicating a value to add to the stored balance.

In some other examples, the user of the client device 102-a can provide user input selecting a button element labeled with “Go back” to suspend or cancel transmission of the instance of the application 402-a to the other client device. If the button element for changing a payment method and/or adding funds is selected, then the client device 102-a can display another application or a window in the instance of the application 402-a that includes additional interactable elements 408 for increasing a stored balance or updating a payment instrument for an account of the user of the client device 102-a. The client device 102-a can receive user input increasing the stored balance from a first value to a second value. For example, the user input can indicate an increase in the stored balance from $23.45 to $123.45, where an example threshold value is $100.

In some examples, at a time after displaying the instance of the application 402-a, the client device 102-a can display an instance of the application 402-b. The instance of the application 402-b can be an instance of a same application as the instance of the application 402-a. If the client device 102-a detects that a stored balance is updated (e.g., increased) to satisfy the threshold value, then the client device 102-a can display the instance of the application 402-b. For example, the client device 102-a can receive a message indicating an update to the stored balance 410 from a payment service system. The stored balance can be increased by a numerical value, such as $100. In some other examples, the client device 102-a can detect the update to the stored balance 410 by receiving user input that indicates the update to the stored balance 410. The instance of the application 402-b can include display of the updated stored balance (e.g., a numerical value of $123.45) via the user interface 114.

Additionally, or alternatively, the instance of the application 402-b can include a prompt 412 displayed via the user interface 114. The prompt 412 can include a text value including one or more string and/or character values. For example, the prompt 412 can include a text value, “Funds updated. Please confirm transfer of application to client device XYZ,” where XYZ is an identifier of a target client device and/or a user of the target client device. The client device 102-a can additionally, or alternatively, display one or more interactable elements 408 to the user of the client device 102-a via the user interface user interface 114 of the instance of the application 402-b. The client device 102-a can receive user input selecting one or more of the interactable elements 408. For example, a user of the client device 102-a can provide user input selecting a button element labeled with “Confirm” to confirm a transmission including the instance of the application 402-b to a target client device (e.g., by clicking the button element). In some other examples, the user of the client device 102-a can provide user input selecting a button element labeled with “Cancel” to cancel the transmission including the instance of the application 402-b to the target client device.

In some examples, such as if the user of the client device 102-a selects the button element that confirm transfer of the instance of the application 402-b, the client device 102-a transmits the instance of the application 402-b to the target client device. In some other examples, such as if the user of the client device 102-a selects the button element that cancels transfer of the instance of the application 402-b, the client device 102-a can refrain from transmitting or cancel transmission of the instance of the application 402-b to the target client device. Although the system 400 illustrates an example of user input triggering a transmission including an instance of the application 402-b, the client device 102-a can additionally, or alternatively, perform the transmission including the instance of the application 402-b without user input. For example, the client device 102-a performs the transmission including the instance of the application 402-b without displaying the prompt 412 and the interactable elements 408. The client device 102-a can detect a trigger condition or event and can initiate the transmission including the instance of the application 402-b, as described with reference to FIG. 1. In variations the trigger condition can include detecting or receiving an indication of the update to the stored balance 410, where the updated stored balance satisfies the threshold value. In some cases, the client device 102-a can display a notification or message to the user of the client device 102-a that indicates the transmission including the instance of the application 402-b is sent to the target client device.

FIG. 5 illustrates an example system 500 for data transaction application transmission across devices in accordance with one or more implementations as described herein. The system 500 may implement aspects of the example system 100, the process flow 200, the system 300, and/or the system 400 as shown and described with reference to FIGS. 1 through 4. For example, the example system 500 may include a client device 102-a configured to transfer an instance of an application 502-a and/or an instance of the application 502-b to another client device, where the client device 102-a and the application may be examples of the corresponding features as described with reference to FIGS. 1 through 3. In variations, the client device 102-a includes a user interface 114, which may be an example of a user interface 114 as described with reference to FIG. 1. For example, the client device 102-a displays the instance of the application 502-a and/or the instance of the application 502-b via the user interface 114.

The client device 102-a can display a stored balance via the user interface 114, such as a numerical value indicating the stored balance (e.g., $123.45). The stored balance can be any monetary value accessible by a user of the client device 102-a. In some cases, the client device 102-a can maintain the stored balance. In some other cases, a payment service system can maintain the stored balance and can communicate any changes to the stored balance to the client device 102-a for display. Maintaining the stored balance includes updating the stored balance when the account of the user of the client device 102-a is credited or withdrawn from, as described with reference to FIGS. 1 and 4.

A client device 102-a can detect a request to transfer an instance of an application 504 (e.g., the instance of the application 502-a) to another client device, as described with reference to FIG. 3. Once the client device 102-a receives the request to transfer the instance of the application 504, the client device 102-a can determine whether the other client device is authorized to initiate a data transaction via the application. For example, the client device 102-a can compare a user identifier of the other client device, which may be referred to as a target client device, to a list of user identifiers that are authorized to initiate a data transaction on behalf of a user of the client device 102-a. In variations, the list of user identifiers can be configured or defined via user input provided by the user of the client device 102-a.

If the client device 102-a determines that the user of the target client device and/or that the target client device is not authorized to initiate a data transaction on behalf of the user of the client device 102-a (e.g., is not on the list of user identifiers for authorized users), then the client device 102-a can display a prompt 506 to the user of the client device 102-a via a user interface 114 of the instance of the application 502-a. The prompt 506 can include a text value including one or more string and/or character values. For example, the prompt 506 can include a text value, “Unauthorized user for transaction. Please authorize user XYZ,” where XYZ is a user identifier of a user of a target client device or an identifier of the target client device. In some other examples, such as if the client device 102-a determines that the user of the target client device and/or that the target client device is authorized to initiate a data transaction on behalf of the user of the client device 102-a (e.g., is on the list of user identifiers for authorized users), the client device 102-a can display a prompt for transferring the application 502-a to the target client device and/or can initiate transfer of the instance of the application 502-a to the target client device, as described with reference to FIG. 3.

The client device 102-a can additionally, or alternatively, display one or more interactable elements 508 to the user of the client device 102-a via the user interface user interface 114 of the instance of the application 502-a. The interactable elements 508 can include, but are not limited to, button elements, drop-down menus, text field elements, or the like. The client device 102-a can receive user input selecting one or more of the interactable elements 508. For example, a user of the client device 102-a can provide user input by selecting a button element labeled with “Authorize user XYZ” (e.g., by clicking the button element). In some other examples, the user of the client device 102-a provides user input selecting a button element labeled with “Go back” to suspend or cancel transmission of the instance of the application 502-a to the other client device. If the button element for authorizing the user and/or target client device with the identifier XYZ is selected, then the client device 102-a can authorize the user and/or the target client device for performing a data transaction via the application. For example, the client device 102-a can receive authorization input 510 indicating that the user of the target client device and/or that the target client device is authorized to perform a data transaction via the instance of the application 502-b.

In some examples, at a time after displaying the instance of the application 502-a, the client device 102-a can display an instance of the application 502-b. The instance of the application 502-b can be an instance of a same application as the instance of the application 502-a. If the client device 102-a receives the authorization input 510, then the client device 102-a can display the instance of the application 502-b. The instance of the application 502-b can include display of the stored balance (e.g., a numerical value of $123.45) via the user interface 114. Additionally, or alternatively, the instance of the application 502-b can include a prompt 512 displayed via the user interface 114. The prompt 512 can include a text value including one or more string and/or character values. For example, the prompt 512 can include a text value, “User XYZ authorized. Please confirm transfer of application to client device XYZ,” where XYZ is an identifier of a target client device and/or a user of the target client device.

The client device 102-a can additionally, or alternatively, display one or more interactable elements 508 to the user of the client device 102-a via the user interface user interface 114 of the instance of the application 502-b. The client device 102-a can receive user input selecting one or more of the interactable elements 508. For example, a user of the client device 102-a can provide user input selecting a button element labeled with “Confirm” to confirm a transmission including the instance of the application 502-b to a target client device (e.g., by clicking the button element). In some other examples, the user of the client device 102-a can provide user input selecting a button element labeled with “Cancel” to cancel the transmission including the instance of the application 502-b to the target client device.

In some examples, such as if the user of the client device 102-a selects the button element that confirm transfer of the instance of the application 502-b, the client device 102-a transmits the instance of the application 502-b to the target client device. In some other examples, such as if the user of the client device 102-a selects the button element that cancels transfer of the instance of the application 502-b, the client device 102-a can refrain from transmitting or cancel transmission of the instance of the application 502-b to the target client device. Transferring the instance of the application 502-a and/or the instance of the application 502-b can include transferring access to the stored balance to another client device.

Although the system 500 illustrates an example of user input triggering a transmission including an instance of the application 502-b, the client device 102-a can additionally, or alternatively, perform the transmission including the instance of the application 502-b without user input. For example, the client device 102-a performs the transmission including the instance of the application 502-b without displaying the prompt 512 and the interactable elements 508. The client device 102-a can detect a trigger condition or event and can initiate the transmission including the instance of the application 502-b, as described with reference to FIG. 1. In variations the trigger condition can include detecting or receiving the authorization input 510. In some cases, the client device 102-a can display a notification or message to the user of the client device 102-a that indicates the transmission including the instance of the application 502-b is sent to the target client device.

FIG. 6 illustrates an example system 600 for data transaction application transmission across devices in accordance with one or more implementations as described herein. The system 600 may implement aspects of the example system 100, the process flow 200, the system 300, the system 400, and/or the system 500 as shown and described with reference to FIGS. 1 through 5. For example, the example system 600 may include a client device 102-b configured to receive an instance of an application 602 from another client device, where the client device 102-b and the application may be examples of the corresponding features as described with reference to FIGS. 1 through 3. In variations, the client device 102-b includes a user interface 114, which may be an example of a user interface 114 as described with reference to FIG. 1. For example, the client device 102-b displays the instance of the application 602 via the user interface 114.

The client device 102-b can display a stored balance via the user interface 114, such as a numerical value indicating the stored balance (e.g., $123.45). The stored balance can be any monetary value accessible by a user of the client device 102-b via the instance of the application 602. The stored balance can be maintained by one or more other devices, such as a device implementing a payment service system and/or a client device that sends the instance of the application 602 to the client device 102-b (e.g., a client device 102-a, as described with reference to FIGS. 1 through 5).

A client device 102-b can detect a request to execute a data transaction 604 via the instance of the application 602. The instance of the application 602 can include a display of one or more items for purchase via the instance of the application 602. For example, if the application is an online marketplace application, a food delivery service application, and/or any other application that supports purchase of an item for sale, then the instance of the application 602 can include a display of a summary of items selected for purchase (e.g., a cart that displays the items for purchase). The client device 102-b can receive user input indicating the selection of the items for purchase. For example, the instance of the application 602 can provide for a user to browse one or more items listed for sale via the application and select one or more items to purchase from the items listed for sale.

The client device 102-b can display a total value for the purchase of the items in the cart via the user interface 114. For example, the total value can include a numerical value (e.g., $32.25), which may be greater than a value of an initial stored balance prior to an update to the stored balance (e.g., $23.45, as described with reference to FIG. 4). If the total value exceeds the stored balance, then the client device 102-b can display a notification via the user interface 114 that indicates to the user that the total value exceeds the stored balance, and requests for the user of the client device 102-b to remove one or more items from the cart. If the total satisfies (e.g., is less than) the stored balance, then the client device 102-b can display one or more interactable elements 606 to confirm a data transaction to purchase the items.

The client device 102-b can display one or more interactable elements 606 to the user of the client device 102-b via the user interface user interface 114 of the instance of the application 602. The interactable elements 606 can include, but are not limited to, button elements, drop-down menus, text field elements, or the like. The client device 102-b can receive user input selecting one or more of the interactable elements 606. For example, a user of the client device 102-b can provide user input by selecting a button element labeled with “Confirm” (e.g., by clicking the button element) to confirm or initiate a data transaction to purchase one or more items. The request to execute the data transaction 604 can include receiving user input selecting the button element to confirm the data transaction. In some other examples, the user of the client device 102-a provides user input selecting a button element labeled with “Cancel” to suspend or cancel a data transaction to purchase one or more items.

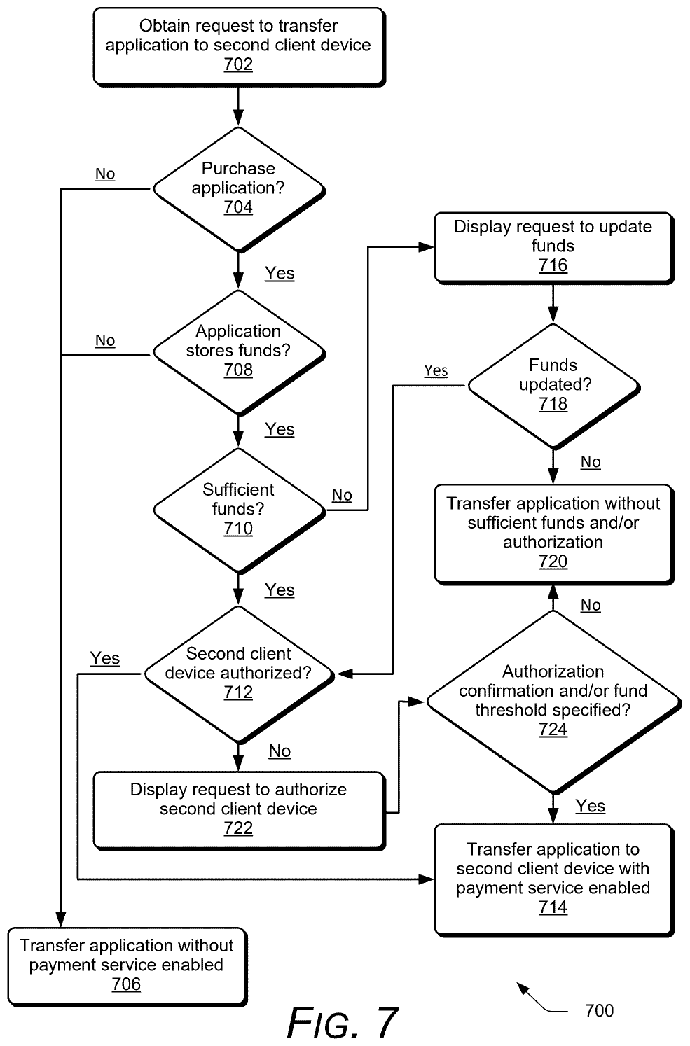

FIG. 7 illustrates an example block diagram 700 for data transaction application transmission across devices in accordance with one or more implementations as described herein. The block diagram 700 may implement aspects of the system 100, as well as any of the process flow 200, the system 300, the system 400, the system 500, or the system 600. For example, the example block diagram 700 can be implemented by a client device 102-a, which may be an example of the client device 102-a as described with reference to FIGS. 1 through 6. Alternative examples of the following may be implemented, where some processes are performed in a different order than described or are not performed. In some cases, processes may include additional features not mentioned below, or further processes may be added.

At 702, a request to transfer an application to a second client device is received. For example, a first client device (e.g., a client device 102-a, as described with reference to FIGS. 1 through 5) can receive user input indicating for the first client device to transmit an instance of an application to a second client device.

At 704, a determination is made as to whether the application is a purchase application. An application may be a purchase application if the application enables functionality to pay for one or more items (e.g., using a stored balance). If the application is not a purchase application (e.g., “No”), then at 706, the application is transferred without payment services enabled. For example, the first client device can transfer the application to the second client device without providing a stored balance and/or authorization to the second client device for a data transaction. If the application is a purchase application (e.g., “Yes”), then at 708, a determination is made as to whether the application stores funds. For example, the first client device can determine if the application has a wallet functionality and/or a stored balance. If the application does not store funds (e.g., “No”), then at 706, the application is transferred without payment services enabled.

If the application does store funds (e.g., “Yes”), then at 710, a determination is made as to whether the funds are sufficient. For example, the first client device can compare a stored balance of an instance of the application to a threshold value. If the stored balance is equal to or exceeds the threshold value (e.g., “Yes”), then at 712, a determination is made as to whether the second client device is authorized. For example, the first client device can determine whether the second client device has authorization to access the funds (e.g., withdraw from the funds) stored by the instance of the application. If the second client device is authorized (e.g., “Yes”), then at 714, the application is transferred to the second client device with payment service enabled.

If the stored balance does not exceed the threshold value (e.g., “No”), then at 716, a request to update the funds is displayed. For example, the first client device alerts a user of the first client device via a user interface to provide sufficient funds (e.g., increase a stored balance). The request can be output via the user interface for display and can include a text value requesting the user increase the funds and/or indicating the threshold value. At 718, a determination is made as to whether the funds are updated. If the user updates a stored balance, such that the stored balance satisfies the threshold value, then the first client device can determine that the funds are updated. If the funds are updated (e.g., “Yes”), then at 712 a determination is made as to whether the second client device is authorized. If the second client device is authorized (e.g., “Yes”), then at 714, the application is transferred to the second client device with payment service enabled.

If the funds are not updated (e.g., “No”), then at 720 the application is transferred without sufficient funds. If the second client device is not authorized (e.g., “No”), then at 722, a request to authorize the second client device is displayed. For example, the first client device can display a message to the user of the first client device requesting user input authorizing a user of the second client device and/or authorizing the second client device to access (e.g., spend) the funds. At 724, a determination is made as to whether an authorization confirmation is received and/or whether a fund threshold is specified. The fund threshold can be an example of the threshold value and can be defined or configured for respective client devices. If the authorization confirmation is received and/or the fund threshold is satisfied (e.g., “Yes”), then at 714 the application is transferred with payment services enabled. If the authorization confirmation is not received and/or the fund threshold is not satisfied (e.g., “No”), then at 720 the application is transferred without sufficient funds and/or authorization.

In some examples, the first client device can specify the threshold value, and the second device can determine a purchase amount (e.g., a value for purchasing one or more items) for a data transaction exceeds the threshold value. The second client device can send an authorization request to initiate the data transaction. The first client device can transmit signaling to the second client device approving or denying the request in accordance with user input.

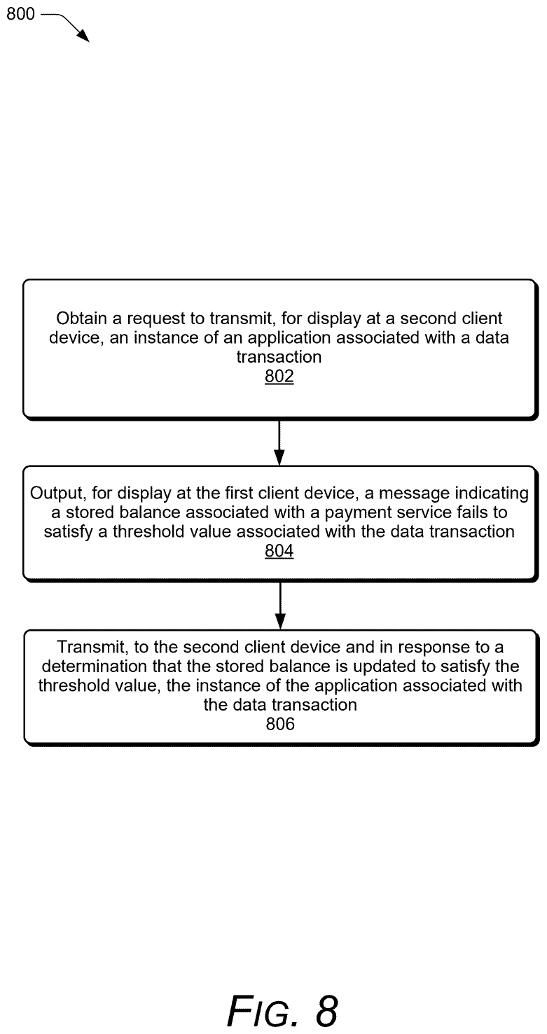

FIG. 8 illustrates one or more example methods 800 for data transaction application transmission across devices. The order in which the method is described is not intended to be construed as a limitation, and any number or combination of the described method operations can be performed in any order to perform a method, or an alternate method.

At 802, a request to transmit, for display at a second client device, an instance of an application associated with a data transaction is obtained. In some cases, user input is received via the client device 102 that explicitly indicates the request. In some other cases, the client device 102 obtains the request via an implicit indication, as described with reference to FIG. 3. The client device 102 obtains user input via at least one of an interactable element of a user interface displayed at the first client device or a sensor of the first client device that indicates the request to transmit the instance of the application associated with the data transaction.

At 804, a message is output for display at the first client device indicating a stored balance associated with a payment service fails to satisfy (e.g., is less than) a threshold value associated with the data transaction.

At 806, the instance of the application associated with the data transaction is transmitted to the second client device in response to a determination that the stored balance is updated to satisfy the threshold value. For example, the client device 102 receives an indication that the stored balance is updated to satisfy the threshold value, where the determination is based on the received indication. In some other examples, the client device 102 receives an indication of a maximum value associated with the stored balance, where the maximum value satisfies the threshold value. In some cases, the client device 102 detects expiry of a timer associated with the message, where the timer is initiated based on outputting the message and transmits the instance of the application upon detection of the expiry of the timer.

In some examples, the client device 102 outputs an additional message requesting authorization of the second client device to initiate the data transaction via the instance of the application. The client device 102 obtains user input authorizing the second client device to initiate execution of the data transaction via the instance of the application in response to the additional message. The data transaction can include a payment transaction associated with a purchase of at least one item via the instance of the application, where the data transaction is associated with a value. The client device 102 can output an additional message for display at the first client device requesting authorization to execute the data transaction based on the value exceeding a maximum value for a data transaction associated with the second client device. The client device 102 receives a request to execute the data transaction via the instance of the application, where the value is deducted from the stored balance based at least in part on executing the data transaction.

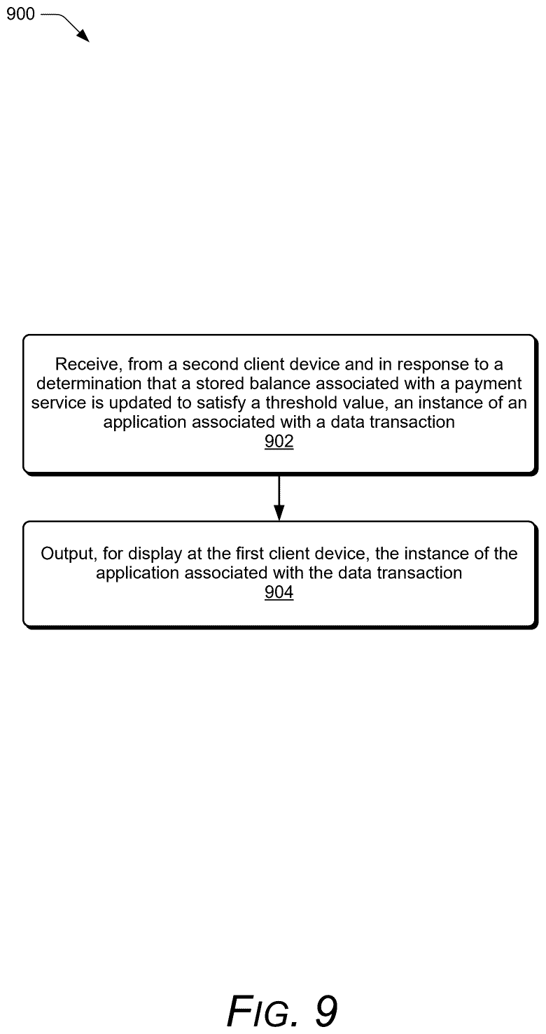

FIG. 9 illustrates one or more example methods 900 for data transaction application transmission across devices. The order in which the method is described is not intended to be construed as a limitation, and any number or combination of the described method operations can be performed in any order to perform a method, or an alternate method.

At 902, an instance of an application associated with a data transaction is received from a second client device and in response to a determination that a stored balance associated with a payment service is updated to satisfy a threshold value. In some examples, the instance of the application associated with the data transaction is received based on expiry of a timer associated with a message indicating the stored balance associated with the payment service fails to satisfy the threshold value associated with the data transaction.

At 904, the instance of the application associated with the data transaction is output for display at the first client device. The data transaction can include a payment transaction associated with a purchase of at least one item via the instance of the application, where the data transaction is associated with a value that satisfies the threshold value.

The client device 102 can obtain a request to execute the data transaction via an interactable element of a user interface displaying the instance of the application associated with the data transaction. The client device 102 can execute the data transaction based on the request. The client device 102 can transmit a message that indicates confirmation of the data transaction to the second client device. In some examples, the client device 102 determines that a user of the first client device is authorized to initiate the data transaction via the instance of the application prior to transmitting the message. Additionally, or alternatively, the client device 102 determines that the value associated with the data transaction is less than or equal to the stored balance prior to transmitting the message. In some examples, the value associated with the data transaction is deducted from the stored balance based on the transmitted message that indicates the confirmation of the data transaction.

FIG. 10 illustrates various components of an example device 1000, which can implement aspects of the techniques and features for data transaction application transmission across devices, as described herein. The example device 1000 can be implemented as any of the devices described with reference to the previous FIGS. 1 through 9, such as any type of a wireless device, mobile device (e.g., the client device 102), mobile phone, flip phone, client device, companion device, paired device, display device, tablet, computing, communication, entertainment, gaming, media playback, and/or any other type of computing, consumer, and/or electronic device. For example, the client device 102 described with reference to FIGS. 1 through 9 may be implemented as the example device 1000.

The example device 1000 can include various, different communication devices 1002 that enable wired and/or wireless communication of device data 1004 with other devices. The device data 1004 can include any of the various device's data and content that is generated, processed, determined, received, stored, and/or communicated from one computing device to another. Generally, the device data 1004 can include any form of audio, video, image, graphics, and/or electronic data that is generated by applications executing on a device. The communication devices 1002 can also include transceivers for cellular phone communication and/or for any type of network data communication.

The example device 1000 can also include various, different types of data input/output (I/O) interfaces 1006, such as data network interfaces that provide connection and/or communication links between the devices, data networks, and other devices. The I/O interfaces 1006 can be used to couple the device to any type of components, peripherals, and/or accessory devices, such as a computer input device that may be integrated with the example device 1000. The I/O interfaces 1006 may also include data input ports via which any type of data, information, media content, communications, messages, and/or inputs can be received, such as user inputs to the device, as well as any type of audio, video, image, graphics, and/or electronic data received from any content and/or data source.

The example device 1000 includes a processor system 1008 of one or more processors (e.g., any of microprocessors, controllers, and the like) and/or a processor and memory system implemented as a system-on-chip (SoC) that processes computer-executable instructions. The processor system 1008 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 1010. The example device 1000 may also include any type of a system bus or other data and command transfer system that couples the various components within the device. A system bus can include any one or combination of different bus structures and architectures, as well as control and data lines.

The example device 1000 also includes memory and/or memory devices 1012 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 1012 include volatile memory and non-volatile memory, fixed and removable media devices, and any suitable memory device or electronic data storage that maintains data for computing device access. The memory devices 1012 can include various implementations of random-access memory (RAM), read-only memory (ROM), flash memory, and other types of storage media in various memory device configurations. The example device 1000 may also include a mass storage media device.

The memory devices 1012 (e.g., as computer-readable storage memory) provide data storage mechanisms, such as to store the device data 1004, other types of information and/or electronic data, and various device applications 1014 (e.g., software applications and/or modules). For example, an operating system 1016 can be maintained as software instructions with a memory device 1012 and executed by the processor system 1008 as a software application. The device applications 1014 may also include a device manager, such as any form of a control application, software application, signal-processing and control module, code that is specific to a particular device, a hardware abstraction layer for a particular device, and so on.

In this example, the device 1000 includes an application transfer system 1018 that implements various aspects of the described features and techniques described herein. The application transfer system 1018 can be implemented with hardware components and/or in software as one of the device applications 1014, such as when the example device 1000 is implemented as the client device 102 described with reference to FIGS. 1 through 9. An example of the application transfer system 1018 is the application transfer system 110 implemented in the client device 102, such as a software application and/or as hardware components in the wireless device. In implementations, the application transfer system 1018 may include independent processing, memory, and logic components as a computing and/or electronic device integrated with the example device 1000.

The example device 1000 can also include a microphone 1020 and/or camera devices 1022, as well as proximity and/or motion sensors 1024, such as may be implemented as components of an inertial measurement unit (IMU). The proximity and/or motion sensors 1024 can be implemented with various sensors, such as a gyroscope, an accelerometer, and/or other types of motion sensors to sense motion of the device. The motion sensors 1024 can generate sensor data vectors having three-dimensional parameters (e.g., rotational vectors in x, y, and z-axis coordinates) indicating location, position, acceleration, rotational speed, and/or orientation of the device. The example device 1000 can also include one or more power sources 1026, such as when the device is implemented as a wireless device and/or a client device 102. The power sources may include a charging and/or power system, and can be implemented as a flexible strip battery, a rechargeable battery, a charged super-capacitor, and/or any other type of active or passive power source.

The example device 1000 can also include an audio and/or video processing system 1028 that generates audio data for an audio system 1030 and/or generates display data for a display system 1032. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 1000. Alternatively, the audio system and/or the display system are external, peripheral components to the example device.

In some aspects, the techniques described herein relate to a first client device including one or more processors, and one or more memory configured to cause the one or more processors to obtain a request to transmit, for display at a second client device, an instance of an application associated with a data transaction, output, for display at the first client device, a message indicating a stored balance associated with a payment service fails to satisfy a threshold value associated with the data transaction, and transmit, to the second client device and in response to a determination that the stored balance is updated to satisfy the threshold value, the instance of the application associated with the data transaction.

In some aspects, the techniques described herein relate to a first client device, where the one or more processors are further configured to receive an indication that the stored balance is updated to satisfy the threshold value, and where the determination is based on the received indication.

In some aspects, the techniques described herein relate to a first client device, where the one or more processors are further configured to receive an indication of a maximum value associated with the stored balance, and where the maximum value satisfies the threshold value.

In some aspects, the techniques described herein relate to a first client device, where the one or more processors are further configured to output an additional message requesting authorization of the second client device to initiate the data transaction via the instance of the application, and obtain, in response to the additional message, user input authorizing the second client device to initiate execution of the data transaction via the instance of the application.

In some aspects, the techniques described herein relate to a first client device, where to obtain the request, the one or more processors are further configured to obtain, via at least one of an interactable element of a user interface displayed at the first client device or a sensor of the first client device, user input that indicates the request to transmit the instance of the application associated with the data transaction.

In some aspects, the techniques described herein relate to a first client device, where to transmit the instance of the application associated with the data transaction, the one or more processors are further configured to detect expiry of a timer associated with the message, and where the timer is initiated based on outputting the message.

In some aspects, the techniques described herein relate to a first client device, where the data transaction includes a payment transaction associated with a purchase of at least one item via the instance of the application, and where the data transaction is associated with a value that satisfies the threshold value.

In some aspects, the techniques described herein relate to a first client device, where the one or more processors are further configured to output, for display at the first client device, an additional message requesting authorization to execute the data transaction based on the value exceeding a maximum value for the data transaction associated with the second client device.

In some aspects, the techniques described herein relate to a first client device, where the one or more processors are further configured to receive, via the instance of the application, a request to execute the data transaction, and where the value is deducted from the stored balance based at least in part on executing the data transaction.

In some aspects, the techniques described herein relate to a method including obtaining a request to transmit, for display at a second client device, an instance of an application associated with a data transaction, outputting, for display at a first client device, a message indicating a stored balance associated with a payment service fails to satisfy a threshold value associated with the data transaction, and transmitting, to the second client device and in response to a determination that the stored balance is updated to satisfy the threshold value, the instance of the application associated with the data transaction.

In some aspects, the techniques described herein relate to a method, further including receiving an indication that the stored balance is updated to satisfy the threshold value, where the determination is based on the received indication.

In some aspects, the techniques described herein relate to a method, further including receiving an indication of a maximum value associated with the stored balance, where the maximum value satisfies the threshold value.

In some aspects, the techniques described herein relate to a method, further including outputting an additional message requesting authorization of a user of the second client device to initiate the data transaction via the instance of the application, and obtaining, in response to the additional message, user input authorizing the user of the second client device to initiate the data transaction via the instance of the application.

In some aspects, the techniques described herein relate to a method, where obtaining the request includes obtaining, via at least one of an interactable element of a user interface displayed at the first client device or a sensor of the first client device, user input that indicates the request to transmit the instance of the application associated with the data transaction.

In some aspects, the techniques described herein relate to a first client device including one or more processors, and one or more memory configured to cause the one or more processors to receive, from a second client device and in response to a determination that a stored balance associated with a payment service is updated to satisfy a threshold value, an instance of an application associated with a data transaction, and output, for display at the first client device, the instance of the application associated with the data transaction.

In some aspects, the techniques described herein relate to a first client device, where the one or more processors are further configured to obtain, via an interactable element of a user interface displaying the instance of the application associated with the data transaction, a request to execute the data transaction, where the data transaction includes a payment transaction associated with a purchase of at least one item via the instance of the application, and where the data transaction is associated with a value, execute the data transaction based on the request, and transmit, to the second client device, a message that indicates confirmation of the data transaction.

In some aspects, the techniques described herein relate to a first client device, where the value associated with the data transaction is deducted from the stored balance based on the transmitted message that indicates the confirmation of the data transaction.

In some aspects, the techniques described herein relate to a first client device, where to transmit the message, the one or more processors are further configured to determine that a user of the first client device is authorized to initiate the data transaction via the instance of the application.

In some aspects, the techniques described herein relate to a first client device, where to transmit the message, the one or more processors are further configured to determine that the value associated with the data transaction is less than or equal to the stored balance.

In some aspects, the techniques described herein relate to a first client device, where the instance of the application associated with the data transaction is received based on expiry of a timer associated with a message indicating the stored balance associated with the payment service fails to satisfy the threshold value associated with the data transaction.

1. A first client device comprising:
one or more processors; and
one or more memory configured to cause the one or more processors to:
obtain a request to transmit, for display at a second client device, an instance of an application associated with a data transaction;
output, for display at the first client device, a message indicating a stored balance associated with a payment service fails to satisfy a threshold value associated with the data transaction; and
transmit, to the second client device and in response to a determination that the stored balance is updated to satisfy the threshold value, the instance of the application associated with the data transaction.

2. The first client device of claim 1, wherein the one or more processors are further configured to receive an indication that the stored balance is updated to satisfy the threshold value, and wherein the determination is based on the received indication.

3. The first client device of claim 1, wherein the one or more processors are further configured to receive an indication of a maximum value associated with the stored balance, and wherein the maximum value satisfies the threshold value.

4. The first client device of claim 1, wherein the one or more processors are further configured to:
output an additional message requesting authorization of the second client device to initiate the data transaction via the instance of the application; and
obtain, in response to the additional message, user input authorizing the second client device to initiate execution of the data transaction via the instance of the application.

5. The first client device of claim 1, wherein to obtain the request, the one or more processors are further configured to obtain, via at least one of an interactable element of a user interface displayed at the first client device or a sensor of the first client device, user input that indicates the request to transmit the instance of the application associated with the data transaction.

6. The first client device of claim 1, wherein to transmit the instance of the application associated with the data transaction, the one or more processors are further configured to detect expiry of a timer associated with the message, and wherein the timer is initiated based on outputting the message.

7. The first client device of claim 1, wherein the data transaction comprises a payment transaction associated with a purchase of at least one item via the instance of the application, and wherein the data transaction is associated with a value that satisfies the threshold value.

8. The first client device of claim 7, wherein the one or more processors are further configured to output, for display at the first client device, an additional message requesting authorization to execute the data transaction based on the value exceeding a maximum value for the data transaction associated with the second client device.

9. The first client device of claim 7, wherein the one or more processors are further configured to receive, via the instance of the application, a request to execute the data transaction, and wherein the value is deducted from the stored balance based at least in part on executing the data transaction.

10. A method comprising:
obtaining a request to transmit, for display at a second client device, an instance of an application associated with a data transaction;
outputting, for display at a first client device, a message indicating a stored balance associated with a payment service fails to satisfy a threshold value associated with the data transaction; and
transmitting, to the second client device and in response to a determination that the stored balance is updated to satisfy the threshold value, the instance of the application associated with the data transaction.

11. The method of claim 10, further comprising receiving an indication that the stored balance is updated to satisfy the threshold value, wherein the determination is based on the received indication.

12. The method of claim 10, further comprising receiving an indication of a maximum value associated with the stored balance, wherein the maximum value satisfies the threshold value.

13. The method of claim 10, further comprising:
outputting an additional message requesting authorization of a user of the second client device to initiate the data transaction via the instance of the application; and
obtaining, in response to the additional message, user input authorizing the user of the second client device to initiate the data transaction via the instance of the application.

14. The method of claim 10, wherein obtaining the request comprises obtaining, via at least one of an interactable element of a user interface displayed at the first client device or a sensor of the first client device, user input that indicates the request to transmit the instance of the application associated with the data transaction.

15. A first client device comprising:
one or more processors; and
one or more memory configured to cause the one or more processors to:
receive, from a second client device and in response to a determination that a stored balance associated with a payment service is updated to satisfy a threshold value, an instance of an application associated with a data transaction; and
output, for display at the first client device, the instance of the application associated with the data transaction.

16. The first client device of claim 15, wherein the one or more processors are further configured to:
obtain, via an interactable element of a user interface displaying the instance of the application associated with the data transaction, a request to execute the data transaction, wherein the data transaction comprises a payment transaction associated with a purchase of at least one item via the instance of the application, and wherein the data transaction is associated with a value;
execute the data transaction based on the request; and
transmit, to the second client device, a message that indicates confirmation of the data transaction.

17. The first client device of claim 16, wherein the value associated with the data transaction is deducted from the stored balance based on the transmitted message that indicates the confirmation of the data transaction.

18. The first client device of claim 16, wherein to transmit the message, the one or more processors are further configured to determine that a user of the first client device is authorized to initiate the data transaction via the instance of the application.

19. The first client device of claim 16, wherein to transmit the message, the one or more processors are further configured to determine that the value associated with the data transaction is less than or equal to the stored balance.

20. The first client device of claim 15, wherein the instance of the application associated with the data transaction is received based on expiry of a timer associated with a message indicating the stored balance associated with the payment service fails to satisfy the threshold value associated with the data transaction.
